(19) United States
(12) Patent Application Publication
(10) Pub. No.: US 2026/0139525 A1
(43) Pub. Date: May 21, 2026

(54) Vehicle Door for a Motor Vehicle, in Particular for a Passenger Car, and Motor Vehicle

(71) Applicant: Bayerische Motoren Werke Aktiengesellschaft, Muenchen (DE)

(72) Inventors: Steve BREUNINGER, Gauting (DE); Jacobo DOMINGUEZ OJEA, Muenchen (DE); Markus KOEDDERITZSCH, Woerthsee (DE); Alexander SCHNEIDER, Muenchen (DE)

(21) Appl. No.: 19/114,863

(22) PCT Filed: Oct. 17, 2023
(86) PCT No.: PCT/EP2023/078796

§ 371 Date: Mar. 25, 2025

(30) Foreign Application Priority Data
Oct. 19, 2022 (DE) 10 2022 127 595.7

(51) Int. Cl. E05B 81/90; E05B 81/04

(52) U.S. Cl. CPC E05B 81/90; E05B 81/04

(57) ABSTRACT

A vehicle door for a motor vehicle, comprising a handle element which is arranged on the outer face of the door above the windowsill trim of the vehicle door, wherein an operating element is integrated into the handle element, said operating element being used to electrically unlock a lock, by means of which the vehicle door, which can be arranged on the structure of the motor vehicle such that it can be moved between a closed position and at least one open position, can be secured in the closed position. The handle element is held on the main part of the vehicle door such that it can be moved relative thereto from a rest position (R) into at least one actuation position (B), and the lock can be mechanically unlocked by moving the handle element out of the rest position (R) and into the actuation position (B).

### BACKGROUND AND SUMMARY

This disclosure relates to a vehicle door for a motor vehicle, in particular for a passenger car. The disclosure also relates to a motor vehicle, in particular a passenger car, having at least one such vehicle door.

WO 2007/118552 A1 discloses a motor vehicle with a vehicle door which has a lower door part and an upper window part which are separated by a window sill. WO 2020/01137 A1 discloses a device for actuating a vehicle door of a vehicle, with a sensor device which is set up to detect a force acting on the vehicle door and to generate corresponding sensor data. Furthermore, DE 102017202 114 A1 discloses a motor vehicle with at least one side door having a door body. WO 2006/007916 A1 also discloses a motor vehicle door with an inner module and an outer module. Furthermore, DE 10 2010 101 164 A1 discloses a door handle unit for actuating a lock of a door or a flap.

An object of the present disclosure is to create a vehicle door for a motor vehicle, in particular a passenger car, and also a motor vehicle, so that a particularly advantageous operation can be realized.

A first aspect of the disclosure relates to a vehicle door, also referred to simply as a door and designed, for example, as a side door, for a motor vehicle preferably designed as a passenger car and also referred to as a vehicle. This means that the motor vehicle, also referred to as a motor vehicle or vehicle, the interior of which, also referred to as the passenger cell or passenger compartment, is formed, for example, by a body of the motor vehicle designed in particular as a self-supporting body, comprises the body and the vehicle door in its fully manufactured state. The vehicle door has a handle element which is arranged on the outer side of the door and which, in particular in the installed position of the vehicle door, which assumes its installed position in the fully manufactured state of the motor vehicle, is arranged above a beltline of the vehicle door in the vertical direction of the motor vehicle. The handle element is also referred to as an external handle or external door handle. In the fully manufactured state of the motor vehicle, the vehicle door is movably, in particular pivotably, held on the body, so that the vehicle door can be arranged or is arranged, i.e., is to be held or is held, movably, in particular pivotably, on the body. In particular, the vehicle door is associated with a body opening of the body, the body opening of which is in particular a door opening. If the vehicle door is a side door, the door opening is a side door opening which, for example, is arranged on a left or right side of the body or the vehicle when viewed in the transverse direction of the vehicle. The vehicle door can be moved, in particular pivoted, relative to the body between a closed position and at least one open position. In the closed position, at least part of the body opening is closed by the vehicle door. In the open position, the vehicle door releases the partial region of the body opening so that, for example, a person can enter the interior or exit the interior via the released partial region of the body opening when the vehicle door is in the open position. In particular, it is provided that the handle element is arranged above the beltline in the installed position of the vehicle door and in relation to the closed position of the vehicle door in the vertical direction of the vehicle. The beltline is also simply referred to as a parapet or window sill or edge or flanged edge, or the beltline is formed by a curb or coincides with the curb. In particular, the beltline is or forms an edge, in particular a lower edge, by which, for example, a window opening, also referred to as a window opening, for a window, in particular for a side window, of the vehicle door is at least partially delimited, in particular in the installed position of the vehicle door and in relation to the closed position of the vehicle door in the vertical direction of the motor vehicle.

For example, a person standing in the vicinity of the motor vehicle and thus the vehicle door can grasp the handle element with their hand and, for example, at least partially grip it and, for example, subsequently exert a force on the handle element and thus on the vehicle door via the handle element in order to be able to handle the vehicle door, i.e., in particular to move it relative to the body, in particular to pivot it. For example, the person can exert such a force on the vehicle door via the handle element that the vehicle door is opened by the force, i.e., moved from the closed position to the open position relative to the body. Furthermore, the person in the vicinity can, for example, exert such a force on the handle element and thus on the vehicle door that the vehicle door is closed by the force, i.e., moved from the open position to the closed position. The feature that the handle element is arranged on the outer side of the door or externally, and is therefore an external handle element or a handle element which is arranged on the outer side of the door and thus an outer door handle, is to be understood as meaning that the handle element is arranged on the outer side of the vehicle door, the outer side of which, in the installed position of the vehicle door and at least in the closed position of the vehicle door, faces away from the interior and towards the surroundings.

In order to be able to realize a particularly advantageous operation, i.e., actuation, of the vehicle door, in particular via the handle element, it is provided according to the disclosure that an operating element is integrated into the handle element. This means in particular that the operating element is held on the handle element or is a component of the handle element. In particular, it is conceivable that the operating element is held on a base of the handle element, wherein it is conceivable that the operating element is formed separately from the base. The operating element can be held immovably or movably, in particular pivotably, on the base or on the handle element. The operating element can be used to electrically unlock a lock, also known as a door lock, by way of which the vehicle door, which can be moved, in particular pivoted, between the closed position and the at least one open position on the body of the motor vehicle, can be secured in the closed position, in particular relative to the body. For example, in order to open the vehicle door, which is initially in the closed position and thus closed and secured by way of the lock in the closed position, in particular relative to the body, the person in the vicinity operates, in particular actuates, the operating element, which electrically unlocks the lock, i.e., causes the lock to be electrically unlocked. In particular, the person touches the operating element.

By way of the lock, the vehicle door, which can be moved, in particular pivoted, between the closed position and the at least one open position on the body of the vehicle (motor vehicle), is to be secured or is secured in the closed position, in particular relative to the body, so that undesired movement of the vehicle door from the closed position to the open position is prevented. By unlocking the lock, the lock releases the vehicle door for movement from the closed position to the open position. In particular, the lock can be a component of the vehicle door, so that the lock can, for example, be moved, in particular pivoted, with the vehicle door relative to the body between the closed position and the open position. The lock can, for example, be moved between a locked state and an unlocked state. By unlocking the lock, the lock is moved, i.e., transferred from the locked state to the unlocked state. If the vehicle door is in the closed position, for example, and the lock is in the locked state, the vehicle door is secured in the closed position by way of the lock and thus against undesired movement into the open position relative to the body. It can be seen that the vehicle door is a wing element which can be moved, in particular pivoted, on the body between the open position and the closed position. In particular, the vehicle door (wing element) is an add-on part that is separate from the body and can be held or held on the body so that it can be moved between the open position and the closed position. For example, in order to open the vehicle door, which is initially closed and therefore initially in the closed position, and therefore to move it from the closed position to the open position, the operating element is operated, in particular actuated, by the person in the vicinity. By operating, in particular actuating, the operating element, the lock is electrically unlocked, i.e., electrically transferred from the locked state to the unlocked state, so that the lock releases the vehicle door for a movement relative to the body from the closed position to the open position. For example, a locking element such as a locking bolt, also known as a lock bolt, or a lock bracket, also known as a locking bar, is attached to the body, in particular to a vehicle pillar of the body, which is designed as a door pillar, for example, and is also known as a body pillar. In the closed position of the vehicle door and in the locked state of the lock, for example, the lock, in particular a fork latch of the lock, interacts with the locking element, in particular in a form-fitting manner, whereby the vehicle door can be secured or is secured in the closed position in a form-fitting manner. For example, the lock has a lock element, which can be the aforementioned fork latch, for example. In the closed position of the vehicle door and in the locked state of the lock, for example, the lock element interacts with the locking element, in particular in a form-fitting manner, whereby the vehicle door can be secured or locked in the closed position, in particular in a form-fitting manner. For example, the lock element can be moved relative to a base element of the lock and in particular relative to the locking element between a locking position and an unlocking position, in particular translationally and/or rotationally. In the closed position of the vehicle door and in the locked position of the lock element, the lock element interacts, in particular form-fittingly, with the locking element, whereby the vehicle door can be secured or is secured in the closed position. By or when unlocking the lock, for example, the lock element is moved from the locked position to the unlocked position, in which the lock element does not interact with the locking element. This releases the vehicle door for a movement relative to the body from the closed position to the open position.

The operating element can be, for example, a mechanical operating element such as a knob, a sensing device or a button, so that the operating element can be moved, for example, relative to the handle element and/or relative to the base between an initial position and an operating position, in particular translationally and/or rotationally. By operating, in particular actuating, the operating element, for example, the operating element is moved from the initial position relative to the handle element and/or relative to the base into the operating position, whereby the lock can be electrically unlocked, and consequently whereby the lock can be electrically unlocked. Furthermore, it is conceivable that the operating element is designed as a touch-sensitive surface or comprises a touch-sensitive surface, wherein the operating element is operated, i.e., is to be operated, by touching the touch-sensitive surface.

The feature that the lock can be electrically unlocked by operating, in particular actuating, the operating element means in particular that an electrically operable actuator, in particular an electric motor, is controlled, in particular electrically, for example as a result of operating the operating element. By controlling the actuator, the actuator is operated electrically so that, for example, the lock element is moved from the locked position to the unlocked position by way of the actuator, in particular using electrical energy and therefore electrically. This means that the lock element is moved electrically from the locked position to the unlocked position, whereby the lock is electrically unlocked, i.e., using the aforementioned electrical energy. A movement of the vehicle door from the closed position to the open position following the electrical unlocking of the lock can then, for example, be effected manually by the person in the vicinity, in particular by the person manually exerting a force, in particular a pulling force or a pushing force, on the handle element and thus moving the vehicle door relative to the body from the closed position to the open position. It is also conceivable that, as a result of operating the control element, the vehicle door can be moved or is moved electrically, i.e., using electrical energy, from the closed position to the open position relative to the body, in particular after the lock has been unlocked, in particular electrically. For this purpose, for example, an electrically operable movement device is provided, which for example has the aforementioned electrically operable actuator and/or at least one further electrically operable actuator. As a result of operating the control element, the movement device is activated, for example, in particular electrically, whereby the movement device moves, in particular pivots, the vehicle door from the closed position to the open position using electrical energy and thus electrically relative to the body. This means that the lock can be unlocked particularly conveniently and the vehicle door can be opened particularly conveniently, i.e., moved from the closed position to the open position.

Furthermore, in order to realize a particularly advantageous operation, in particular actuation, of the vehicle door, it is provided that the handle element is held on the base body of the vehicle door so as to be movable, in particular pivotable, relative to a base body, also referred to as the door body, from a rest position into an actuating position, in particular between the rest position and the actuating position, wherein by moving the handle element from the rest position into the actuating position, the lock can be mechanically unlocked, in particular purely and thus preferably without the use of electrical energy. In other words, the lock can be unlocked mechanically, in particular purely mechanically and thus without the use of electrical energy, by moving the handle element relative to the base body from the rest position to the actuating position. Preferably, the rest position and the actuating position are respective end positions of the handle element, which can be moved relative to the base body into the respective end position, but cannot be moved beyond the respective end position. In particular, the vehicle door is designed so that the lock can be electrically unlocked by operating, in particular actuating, the operating element without the handle element moving from the rest position to the actuating position, i.e., while the handle element does not move from the rest position to the actuating position. This makes it possible to achieve a particularly advantageous, in particular a particularly convenient and at the same time safe, operation of the vehicle door. The handle element has at least a dual function: On the one hand, because the operating element is integrated into the handle element, the handle element can be used to unlock the lock electrically and thus particularly conveniently and, for example, to subsequently be able to handle the vehicle door easily, ergonomically and thus advantageously via the handle element. On the other hand, the handle element can function, be designed or be used as an emergency unlocking control element, wherein the emergency unlocking control element is also referred to as an emergency release or emergency unlocking element. This means in particular the following: For example, the operating element is or comprises a sensor, also referred to as a detection sensor, which can be operated electrically or electronically, for example, or can be an electrical or electronic sensor. In particular, the detection sensor can be arranged in the handle element or in the base. The detection sensor can be used, for example, to detect operation of the control element by a person in the vicinity. It is therefore conceivable that the sensor is part of the operating element. If, for example, the detection sensor detects an operation of the control element by the person, i.e., in particular a movement of the control element from the initial position to the operating position caused by the person, the first actuator is activated, in particular as described above, so that the lock is electrically unlocked by way of the first actuator. The first actuator can, for example, be part of the vehicle door. It is also conceivable that the detection sensor is a component of the vehicle door (wing element), in particular in such a way that the detection sensor is integrated into the handle element. In particular, the detection sensor can be the operating element or can be a component of the operating element. In principle, it is possible, for example as a result of an accident involving the motor vehicle, that the operating element and/or the sensor and/or the first actuator can no longer be supplied with electrical energy or electrical current, for example because a power supply to the operating element and/or the first actuator and/or the sensor (detection sensor) is damaged, interrupted or destroyed. The lock can then no longer be electrically unlocked, for example because the first actuator can no longer be operated and/or because an operation or actuation of the operating element can no longer be detected by the detection sensor and/or because the operating element itself can no longer detect its operation. However, since it is now provided according to the disclosure that the handle element itself and thus in particular together with the operating element can be moved relative to the base body from the rest position into the actuating position, whereby the lock can be unlocked mechanically, in particular purely mechanically, the handle element is or functions (also) as an emergency unlocking operating element. This allows the lock to be mechanically unlocked, i.e., in particular emergency unlocked, especially if the power supply has failed. For this purpose, for example, the person in the vicinity moves the handle element and, in particular, the operating element with the handle element from the rest position to the actuating position. In this way, a particularly high level of safety can be achieved, so that particularly advantageous and safe operation is possible. On the other hand, the use of an additional, separate emergency unlocking control element can be avoided, so that a particularly advantageous and safe operation of the vehicle door can be realized in a space-saving, weight-saving and cost-effective manner. In addition, a particularly advantageous visual impression of the vehicle door and the motor vehicle as a whole can be achieved, since, for example, impairment of the visual impression of the motor vehicle by an additional, separate emergency unlocking control element can be avoided.

In order to be able to realize a particularly advantageous operation of the vehicle door, it is provided in one embodiment of the disclosure that the handle element has an outer skin that can be perceived visually and haptically by the person in the vicinity of the vehicle door, in particular of the motor vehicle as a whole. The outer skin of the handle element is also referred to as the outer skin of the handle element. In other words, the person in the vicinity can see the outer skin with their eyes and thus perceive it visually, and the person in the vicinity can, for example, touch the outer skin directly with their hand, in particular with their fingers, and thus perceive it haptically, in particular when the vehicle door and in particular the motor vehicle as a whole is fully assembled. The outer skin is therefore a surface of the handle element that can be perceived visually and haptically by the person in the vicinity or is formed by such a surface. In particular, it is conceivable that the aforementioned touch-sensitive surface is a part of the outer skin of the handle element, also known as the sensing part. In particular, it is conceivable that the vehicle door as a whole has an outer skin that can be perceived visually and haptically by the person in the vicinity, also known as the overall outer skin, wherein the previous and following explanations regarding the outer skin of the handle element can also be readily transferred to the overall outer skin and vice versa. In particular, the outer skin of the handle element is a first part of the overall outer skin. For example, the vehicle door has a body shell, also known as a door shell, wherein it is conceivable, in particular in the fully manufactured state of the motor vehicle, that the vehicle door is to be held or is held on the body of the motor vehicle in a movable, in particular pivotable, manner via the body shell. In other words, for example, the vehicle door is to be held or is held on the body in a movable, in particular pivotable, manner via the body shell. For this purpose, it is provided, for example, that the vehicle door has at least one first hinge part, which is, for example, at least indirectly, in particular directly, attached, in particular fixed, to the body shell. The first hinge part is, for example, a component of a hinge, also known as a door hinge, which also has a second hinge part that is formed in particular separately from the first hinge part. The second hinge part is attached or can be attached at least indirectly, in particular directly, to the body of the motor vehicle, in particular to the aforementioned vehicle pillar. The hinge parts are movably, in particular pivotably, connected or connectable to one another, so that the body shell can be arranged or positioned, i.e., held or retained, on the body via the hinge and the vehicle door as a whole via the body shell in a movable, in particular pivotable, manner. For example, the body shell is at least partially made of a metal material. In particular, it is conceivable that the body shell is part of the base body. It is also conceivable that the vehicle door, in particular the base body, has at least one outer paneling element, also known simply as a paneling element. For example, the outer paneling element is formed separately from the body shell and, in particular, is attached directly to the body shell. The outer paneling element is also referred to as a door panel or outer door panel. At least one region of the body shell is covered and thus clad by the outer paneling element, in particular in relation to the closed position of the vehicle door and in the installed position of the vehicle door to the surroundings and thus to the outer side, i.e., in a direction pointing away from the interior of the motor vehicle. In this case, for example, the outer paneling element has an outer skin, also known as the paneling outer skin, wherein the previous and following explanations regarding the handle element outer skin and the overall outer skin can also be readily transferred to the paneling outer skin and vice versa. For example, the outer skin of the paneling is or forms a second part of the overall outer skin of the vehicle door. In particular, it is conceivable that at least a part of the outer paneling element and thus of the paneling outer skin adjoins the window opening and/or the beltline in the installed position of the vehicle door and, in particular, in the closed position of the vehicle door in the vehicle vertical direction of the motor vehicle.

In order to be able to realize a particularly advantageous operation, in particular actuation, of the vehicle door, it is advantageously provided that the handle element has a first partial region forming a first part of the outer skin of the handle element, also referred to as the first body part, which has a first direction of extent and thus extends along the first direction of extent. It is conceivable that the first partial region protrudes from the base body in or along the first direction of extent. The first direction of extent is also referred to as the first direction. In the installed position of the vehicle door and in the closed position of the vehicle door, for example, the first direction runs in the transverse direction of the vehicle, in particular outwards and thus towards the surroundings. Thus, it is preferably provided that the first partial region protrudes from the base body in the first direction.

Furthermore, the handle element preferably has a second partial region, also referred to as the second body part, which forms a second part of the outer skin of the handle element. The second partial region of the handle element adjoins the first partial region of the handle element, in particular an end of the first partial region of the handle element facing away from the base body, wherein the second partial region of the handle element projects from the first partial region of the handle element in a second direction of extent, which is also referred to as the second direction, extending obliquely or perpendicularly to the first direction of extent (first direction). As a result, for example, the second partial region is spaced apart from the base body and is arranged in at least partial overlap with the base body. In particular, the second partial region extends along the second direction of extent. In the installed position of the vehicle door and in relation to the closed position of the vehicle door, for example, the second direction (second direction of extent) runs upwards in the vertical direction of the vehicle or the second direction points upwards in the vertical direction of the vehicle. For example, in the installed position of the vehicle door and in relation to the closed position of the vehicle door, the second partial region of the handle element is overlapped inwards in the transverse direction of the vehicle and thus towards the interior by the base body and thus, for example, by a part of the outer skin of the paneling. As a result, for example, the person in the vicinity can grasp the handle element, in particular the second partial region of the handle element, with their hand in a particularly advantageous and ergonomic manner, in particular grasp behind it, in particular in such a way that, for example, the person can move at least one of their fingers or several of their fingers between the second partial region of the handle element and the base body. The person can then exert a force particularly advantageously on the handle element in order to be able to handle the vehicle door particularly advantageously, i.e., in particular to be able to move it relative to the body, in particular to be able to pivot it.

In order to be able to realize a haptically particularly advantageous and in particular ergonomic and comfortable operation, in particular actuation, of the vehicle door, it is provided in a further embodiment of the disclosure that, as a result of the second partial region projecting from the first partial region in the second direction of extent, the handle element, in particular viewed as a whole and thus overall, is L-shaped or V-shaped and thus has an L-shape or V-shape. The partial regions of the handle element form the L-shape or the V-shape, wherein the partial regions of the handle element are respective legs of the L-shape or the V-shape. In particular, it is provided that the handle element is connected to the base body via the first partial region of the handle element.

The feature that the handle element is arranged above the beltline in the vertical direction of the vehicle means that the handle element is arranged above the beltline at least in the rest position in the vertical direction of the vehicle. Preferably, the handle element is also arranged above the beltline in the vertical direction of the vehicle in the actuating position.

In particular, the base body has an outer skin, also referred to as the base body outer skin, wherein the previous and following explanations regarding the handle element outer skin, the overall outer skin and the paneling outer skin can also be readily transferred to the base body outer skin and vice versa. At least part of the base body outer skin is the paneling outer skin or is formed by the paneling outer skin. The base body outer skin is therefore part of the overall outer skin of the vehicle door. In particular, it is provided that the first partial region of the handle element protrudes in the first direction (first direction of extent) from the base body outer skin, in particular in the installed position of the vehicle door and in the closed position of the vehicle door towards the surroundings and thus away from the interior. This can ensure a particularly advantageous, in particular a particularly ergonomic and convenient, actuation and thus operation of the vehicle door.

A second aspect of the disclosure relates to a vehicle door, also referred to as a door and designed, for example, as a side door, for a motor vehicle preferably designed as a passenger car and also referred to as a motor vehicle or vehicle. For the first aspect of the disclosure and for the second aspect of the disclosure, it is true that the respective vehicle door can preferably be designed as a side door or as a rear door. Of course, the respective vehicle door can also be designed as a different door. The above comments relating to the first aspect of the disclosure can also be readily applied to the second aspect of the disclosure and vice versa.

The vehicle door according to the second aspect of the disclosure has a handle element which is arranged on the outer side of the door, arranged below a beltline of the vehicle door according to the second aspect of the disclosure, which is thus an external handle also referred to as an external door handle. Advantages and advantageous embodiments of the first aspect of the disclosure are to be regarded as advantages and advantageous embodiments of the second aspect of the disclosure and vice versa. Thus, for example, the vehicle door according to the second aspect of the disclosure can be arranged or is arranged movably, in particular pivotably, on a body of the motor vehicle, in particular such that the vehicle door according to the second aspect of the disclosure can be moved, in particular pivoted, relative to the body between a closed position and at least one open position. In this case, the handle element of the vehicle door according to the second aspect of the disclosure is arranged in the installed position of the vehicle door according to the second aspect of the disclosure and in particular in the closed position of the vehicle door according to the second aspect of the disclosure in the vehicle vertical direction of the motor vehicle below the beltline of the vehicle door according to the second aspect of the disclosure, wherein the vehicle door according to the second aspect of the disclosure assumes its installed position in the completely manufactured state of the motor vehicle.

In the second aspect of the disclosure, an operating element is integrated into the handle element, by way of which a lock, by way of which the vehicle door, which can be arranged on the body of the motor vehicle so as to be movable, in particular pivotable, between the closed position and the at least one open position, can be secured in the closed position, in particular relative to the body, can be electrically unlocked. The handle element is held on the base body so as to be movable relative to a base body of the vehicle door from a rest position into an actuating position, in particular between the rest position and the actuating position, wherein the lock can be unlocked mechanically, in particular purely mechanically, by moving the handle element from the rest position into the actuating position. In the second aspect of the disclosure, the handle element has an outer skin which can be perceived visually and haptically by a person in the vicinity of the vehicle door and is also referred to as the handle element outer skin, wherein the handle element also has a first partial region forming a first part of the handle element outer skin of the handle element, which first partial region is also referred to as the first body region or first body part and has a first direction of extent. The first direction of extent is also referred to as the first direction. The first partial region extends along the first direction of extent. For example, the first partial region of the handle element projects from the base body of the vehicle door in the first direction (first direction of extent). Furthermore, in the second aspect of the disclosure, the handle element has a second partial region forming a second part of the handle element outer skin of the handle element and adjoining the first partial region, which second partial region is also referred to as the second body region or second body part and projects from the first partial region in a second direction of extent extending obliquely or perpendicularly to the first direction. In particular, the second partial region extends along the second direction of extent which is also referred to as the second direction. As a result of the second partial region projecting from the first partial region in the second direction, the second partial region is, for example, spaced apart from the base body and is arranged in at least partial overlap with the base body.

As a result of the second partial region projecting from the first partial region in the second direction of extent (second direction), the handle element, in particular viewed as a whole and thus overall, is L-shaped or V-shaped, so that the handle element, in particular viewed as a whole, has an L-shape or a V-shape. In this case, the L-shape or the V-shape is formed by the partial regions which form or are respective legs of the L-shape or V-shape. Advantages and advantageous embodiments of the first aspect of the disclosure are to be regarded as advantages and advantageous embodiments of the second aspect of the disclosure and vice versa.

Also in the second aspect of the disclosure, the handle element may fulfill at least a dual function. Firstly, the handle element is used, in particular because the operating element is integrated into the handle element, to be able to unlock the lock electrically particularly easily and thus conveniently and ergonomically. Furthermore, the vehicle door can be handled easily, ergonomically and thus conveniently via the handle element. Secondly, also in the second aspect of the disclosure, the handle element can function or be designed as a mechanical emergency unlocking control element, since the lock can be unlocked mechanically, in particular purely mechanically, by moving the handle element relative to the base body from the rest position into the actuating position.

The feature that, in the second aspect, the handle element is arranged below the beltline in the vertical direction of the vehicle is to be understood as meaning that the handle element is arranged below the beltline at least in the rest position in the vertical direction of the vehicle. Preferably, the handle element is also arranged above the beltline in the vertical direction of the vehicle in the actuating position.

Due to the L-shape or the V-shape, the vehicle door can be operated particularly conveniently and ergonomically via the handle element, so that particularly advantageous operation is possible.

In a particularly advantageous embodiment applicable to both aspects of the disclosure, it is provided that the vehicle door has a first guide device provided on the base body. This means in particular that the first guide device is a component of the base body or is held on the base body. For example, the first guide device can be a component of the body shell, or the first guide device is attached at least indirectly, in particular directly, to the body shell. Furthermore, the vehicle door has a second guide device provided on the handle element. Thus, for example, the second guide device is part of the handle element, or the second guide device is held, in particular attached, to the handle element. For example, one of the guide devices, in particular the first guide device, is or comprises a guide link, which is also referred to as a guide track, for example. For example, the other guide device, in particular the second guide device, engages in the guide link. The other guide device, in particular the second guide device, is or comprises, for example, at least one guide element that engages in the guide link, for example. The guide devices interact, in particular in a form-fitting manner, in particular by the guide devices engaging with one another. This can be achieved, for example, by the guide element engaging in the corresponding guide link. Due to the interaction of the guide devices, the handle element can be moved along a path of movement relative to the base body, which is predetermined and therefore defined by the interacting guide devices, from the rest position to the actuating position, in particular between the rest position and the actuating position. This means in particular that the second guide device, in particular the guide element, and with it the handle element can be moved along the first guide device, in particular along the guide link, and thus for example guided relative to the first guide device, in particular relative to the guide link, and relative to the base body, so that or whereby the handle element can be moved or is moved along the path of movement relative to the base body from the rest position into the actuating position, in particular between the rest position and the actuating position. In this way, a simple, convenient and ergonomic movement of the handle element can be realized, in particular from the rest position into the actuating position, so that a particularly simple, convenient and ergonomic actuation and thus operation of the vehicle door can be provided.

Another embodiment is distinguished in that the path of movement is arcuate and therefore curved. For this purpose, for example, the guide track is arcuate and thus curved. This allows a particularly compact and therefore space-saving design to be created. In particular, the guide link is curved, whereby the arcuate path of movement is predetermined, i.e., defined. As a result, for example, the guide link or the one guide device can be designed to be particularly space-saving, so that, for example, the first guide device can be arranged particularly advantageously in a shaft, also known as a pane shaft or window shaft. For example, in the installed position of the vehicle door and in the closed position of the vehicle door, the shaft adjoins the beltline (edge of the vehicle) in the vertical direction of the vehicle. For example, in the installed position of the vehicle door and in the closed position of the vehicle door in the transverse direction of the vehicle, the shaft is at least partially delimited outwards and thus towards the surroundings, in particular directly, by the outer paneling element. The stated window can be displaced relative to the body shell and relative to the outer paneling element, for example in the installed position of the vehicle door in the vehicle vertical direction of the motor vehicle, and can be moved between at least one window closed position and at least one window open position relative to the body shell and relative to the outer paneling element, in particular translationally. At least in the window open position, at least one partial region of the window, also referred to as the window partial region, is arranged in the shaft, in particular in such a way that the window partial region is arranged below the beltline in the installed position of the vehicle door and in the closed position of the vehicle door in the vertical direction of the vehicle. In the window closed position, the window partial region is located outside the shaft and, in particular, above the beltline when the vehicle door is in the installed position and above the beltline when the vehicle door is in the closed position. For example, the shaft ends at the top of the beltline in the installed position of the vehicle door and in relation to the closed position in the vertical direction of the vehicle. In particular, it is conceivable that the guide link or the one guide device is arranged, especially completely, in the shaft. Due to the arcuate design of the guide link and thus the path of movement, a particularly compact structure of the one guide device, in particular the first guide device, can be realized, so that the one guide device, in particular the first guide device, can be arranged particularly advantageously in the shaft.

In order to be able to realize a particularly compact structure, especially of the first guide device, it is provided in a further embodiment of the disclosure that in the installed position of the vehicle door and in the closed position of the vehicle door, the arcuate path of movement or the arcuate guide link is curved towards the interior of the motor vehicle, i.e., convexly curved in the direction of the interior.

It has proven to be particularly advantageous if the rest position of the handle element is a first stable position of the handle element. This means that there is no relative movement between the handle element and the base body in the rest position. For example, a locking device is provided by way of which the handle element is held or can be held in the rest position in such a way that there is no relative movement between the base body and the handle element in the rest position. It has been shown to be particularly advantageous if the actuating position of the handle element is a second stable position of the handle element. This preferably means that the handle element can be moved from the rest position into the actuating position, wherein relative movements between the handle element and the base body do not occur in the actuating position. In other words, a retaining device is provided, for example in the form of a latching device, which is, for example, the locking device or is a component of the locking device. By way of the holding device, the handle element is held or can be held relative to the base body in the actuating position, such that relative movements between the handle element and the base body do not occur in the actuating position of the handle element. In other words, the handle element remains in the actuating position after it has been moved from the rest position to the actuating position, such that in the actuating position relative movements between the base body and the handle element are avoided or prevented, in particular by way of the holding device. As a result, undesired movement of the handle element from the actuating position back into the rest position relative to the base body can be avoided, so that a particularly safe and therefore advantageous operation of the vehicle door can be achieved.

In a further, particularly advantageous embodiment of the disclosure, the vehicle door has a retaining device which secures the handle element relative to the base body in the rest position, also known as the rest position, up to a limit force acting in particular on the handle element and passively, i.e., without the retaining device being actively actuated, allows the movement of the handle element relative to the base body from the rest position to the actuating position when an actuation force acting on the handle element and intended in particular for moving the handle element from the rest position to the actuating position and exerted on the handle element, for example by the person in the vicinity, exceeds the limit force. Thus, for example, the actuating force can be used to move the handle element from the rest position to the actuating position relative to the base body, and in particular only when the actuating force exceeds the limit force. However, the operation of the operating element, i.e., the electrical unlocking of the lock by operating the operating element, can be realized, for example, by way of a force exerted or to be exerted on the operating element that is lower than the limit force. The following is therefore possible: The person in the vicinity can operate the operating element and thereby electrically unlock the lock in such a way that the person exerts a first force on the operating element, for example. If the first force is less than the limit force or if the first force corresponds to the limit force, the lock is electrically unlocked, but the handle element is not moved from the rest position to the actuating position. Then and only then, for example, when the person exerts a second limiting force on the handle element, for example on the operating element and thus for example via the operating element on the handle element, which is greater than the first force and the limiting force, is the handle element moved from the rest position into the actuating position relative to the base body. The limit force is dimensioned in such a way that during normal actuation or operation of the operating element, the handle element does not move from the rest position to the actuating position, i.e., the operating element can be easily and conveniently operated and the lock can therefore be easily and conveniently electrically unlocked without the handle element being accidentally or undesirably moved from the rest position to the actuating position. In simple terms, the person must therefore exert a very high force on the handle element, which is greater than the limit force, in order to mechanically unlock the lock, in particular mechanically unlock it in an emergency, via the handle element.

In order to be able to electrically unlock the lock simply, ergonomically and conveniently by operating the operating element and to avoid mechanical unlocking of the lock, and thus to avoid movement of the handle element from the rest position into the actuating position, it is provided in a further embodiment of the disclosure that the limit force is greater than 50 Newtons, in particular greater than 90 Newtons. Very preferably, the limit force is greater than 95 Newtons, in particular greater than 98 Newtons. In particular, the vehicle door is preferably designed in such a way that the actuating force must be at least 100 newtons in order to move the handle element from the rest position to the actuating position. This means that in normal operation, i.e., when the vehicle has not been involved in an accident, the operating element can be operated advantageously and thus the electrical unlocking of the lock can be effected advantageously without relative movements occurring between the handle element and the base body.

A further embodiment is distinguished in that the handle element can be pivoted about a pivot axis relative to the base body between the rest position and the actuating position. This enables advantageous operation or actuation of the handle element.

It has proven to be particularly advantageous if the pivot axis runs in the vertical or longitudinal direction of the vehicle when the vehicle door is in the installed position and, in particular, when the vehicle door is in the closed position. Furthermore, it is conceivable that the pivot axis runs in the transverse direction of the vehicle when the vehicle door is in the installed position and, in particular, when the vehicle door is in the closed position.

A third aspect of the disclosure relates to a motor vehicle, preferably designed as a passenger car and also referred to as a motor vehicle or vehicle, which has at least one vehicle door according to the first aspect of the disclosure and/or at least one vehicle door according to the second aspect of the disclosure. Advantages and advantageous embodiments of the first aspect of the disclosure and of the second aspect of the disclosure are to be regarded as advantages and advantageous embodiments of the third aspect of the disclosure, and vice versa.

### BRIEF DESCRIPTION OF THE DRAWINGS

Further details of the disclosure can be found in the following description of preferred exemplary embodiments with the associated drawings.

FIG. 1 shows a schematic perspective view of a detail of a vehicle designed as a motor vehicle, in particular as a passenger car, with a vehicle door according to a first embodiment;

FIG. 2 shows a schematic sectional view of a detail of the first embodiment of the vehicle door;

FIG. 3 shows a schematic plan view of a detail of the vehicle door as shown in FIGS. 1 and 2;

FIG. 4 shows a further schematic plan view of a detail of the vehicle door as shown in FIG. 3;

FIG. 5 shows a schematic perspective view of a detail of the motor vehicle with a second embodiment of the vehicle door;

FIG. 6 shows a schematic sectional view of a detail of the second embodiment of the vehicle door;

FIG. 7 shows a schematic sectional view of a detail of a third embodiment of the vehicle door;

FIG. 8 shows a schematic perspective view of a detail of the vehicle with the vehicle door according to a fourth embodiment, wherein a handle element of the vehicle door is in a rest position;

FIG. 9 shows a schematic perspective view of a detail of the vehicle with the vehicle door according to FIG. 8, wherein the handle element is in an actuating position;

FIG. 10 shows a schematic side view of a detail of the vehicle door according to FIGS. 8 and 9, wherein the handle element is in the rest position; and,

FIG. 11 shows a schematic side view of a detail of the vehicle door according to FIGS. 8 to 10, wherein the handle element is in the actuating position.

In the figures, like or functionally like elements are marked with the same reference signs.

### DETAILED DESCRIPTION OF THE DRAWINGS

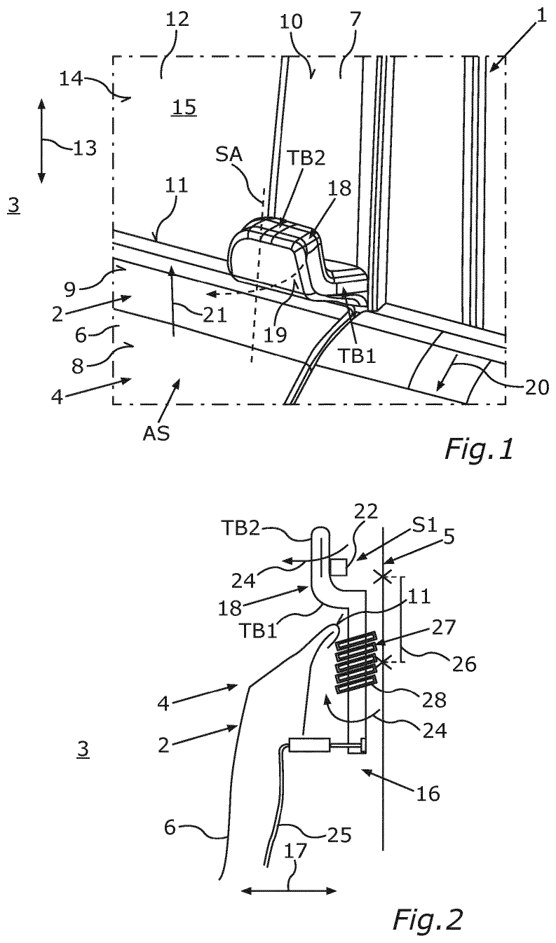

FIG. 1 shows a schematic perspective view of a detail of a motor vehicle 1, which is designed here as a passenger car and is also referred to as a motor vehicle or vehicle, the interior of which, also referred to as the passenger cell or passenger compartment, is formed by a body of the motor vehicle 1, which is designed in particular as a self-supporting body. The motor vehicle 1 has at least one vehicle door 2, which is also referred to simply as a door. The vehicle door 2 is a wing element, which in the present case is designed as the vehicle door 2. The vehicle door 2 is also referred to simply as a door and is a side door in the present case. A body opening of the body is assigned to the vehicle door 2, wherein the body opening is designed as a side door opening of the body in the exemplary embodiment shown in FIG. 1. The vehicle door 2 is mounted on the body so that it can be moved, in particular pivoted, relative to the body between a closed position and at least one open position. In the closed position, at least a partial region of the body opening is closed by the vehicle door 2. In the open position, the vehicle door 2 releases at least the partial region of the body opening so that, for example, a person who is initially in the surroundings 3 of the motor vehicle 1 and thus the vehicle door 2 can enter the interior via the released partial region of the body opening. Furthermore, the person who is initially in the passenger compartment can, for example, exit the passenger compartment via the released partial region of the body opening and thus reach the surroundings 3.

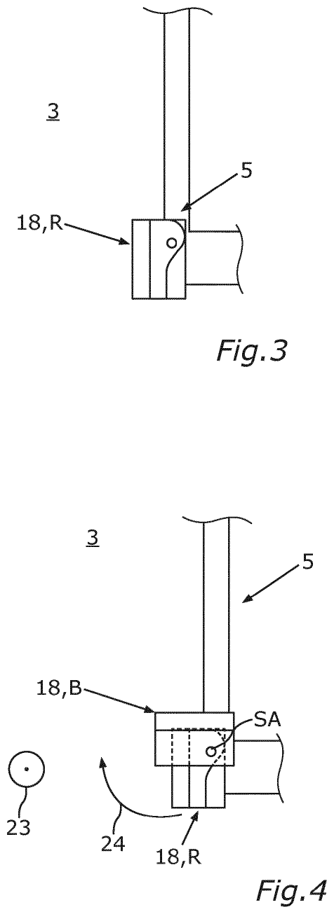

The vehicle door 2 has a base body 4, also referred to as the base body or door body, which has a body shell 5, also referred to as the door shell, which can be seen in detail in FIG. 2. FIGS. 1 to 4 show a first embodiment of the vehicle door 2. The vehicle door 2 is held movably, in particular pivotably, on the body of the motor vehicle 1 via the body shell 5. The base body 4 has at least one outer paneling element 6, also known simply as a paneling element, which is formed separately from the body shell 5 and, in particular, is connected directly to the body shell 5. The outer paneling element 6 is also referred to as door cladding or outer door cladding. At least a first region of the body shell 5 is covered and thus clad by the outer paneling element 6, in particular in relation to the closed position of the vehicle door 2 towards the surroundings 3 and thus towards the outside, i.e., in a direction away from the interior. It can be seen from FIG. 1 that the vehicle door 2 has a cladding element 7, which is designed separately from the outer paneling element 6, for example. For example, the cladding element 7 is held at least indirectly, in particular directly, to the body shell 5. In particular, it is conceivable that at least a second region of the body shell 5, at least in relation to the closed position of the vehicle door 2, overlaps the surroundings 3 and is therefore covered, i.e., clad, by the cladding element 7. The vehicle door 2 has an outer skin, also referred to as the overall outer skin 8, which can be perceived visually and haptically by the person in the vicinity 3 when the vehicle door 2 is in the closed position shown in FIG. 1. A first part of the overall outer skin 8 is formed by an outer skin of the outer paneling element 6, also referred to as the paneling outer skin 9. A second part of the overall outer skin 8 is formed by an outer skin of the cladding element 7, also known as the cladding element outer skin 10. For example, the cladding element 7 is formed from a plastic. For example, the cladding element 7 is designed as a panel, or the cladding element 7 is also referred to as a panel. In particular, it may be provided that, in the closed position of the vehicle door 2, a vehicle pillar of the body, which is designed in particular as a B-pillar, is at least partially overlapped outwards in the transverse direction of the vehicle of the motor vehicle 1 and thus towards the surroundings 3 by way of the cladding element 7, so that the cladding element 7 is also referred to as a B-pillar panel, for example.

It can be seen particularly clearly from FIG. 1 that the vehicle door 2 has a beltline 11, also referred to as a parapet or window sill, which is also referred to as a belt edge or forms a belt edge of the motor vehicle 1. Furthermore, the vehicle door 2 comprises a side window 12, also known simply as a window, which can be displaced relative to the body shell 5 and relative to the outer paneling element 6, at least in relation to the closed position of the vehicle door 2 in the vertical direction of the motor vehicle 1. In particular, the base body 4 comprises, for example, the body shell 5, the outer paneling element 6 and the cladding element 7. Furthermore, the base body 4 can comprise, for example, the side window 12. It is conceivable, for example, that a third part of the overall outer skin 8 is formed by an outer skin of the side window 12, also known as the outer window skin 14. The vertical direction of the vehicle is illustrated by a double arrow 13. In particular, the side window 12 can be moved, i.e., displaced, at least in relation to the closed position of the vehicle door 2 in the vertical vehicle direction of the motor vehicle 1 between a closed position shown in FIG. 1 and an open position, not shown, relative to the body shell 5 and relative to the outer paneling element 6 and also relative to the cladding element 7, in particular translationally. The open position is also referred to as the window open position, and the closed position is also referred to as the window closed position. A window region 15, also referred to as the window region, is at least partially delimited by the beltline 11, in particular in the installed position of the vehicle door 2 and downwards in the vertical direction of the vehicle 1. The installed position of the vehicle door 2 is shown in FIG. 1, wherein the vehicle door 2 assumes its installed position when the motor vehicle 1 with the vehicle door 2 is completely manufactured. In the exemplary embodiment shown in FIG. 1, the pane region (window region 15) is a window opening, also referred to as a pane opening, which can, for example, be defined by a window frame of the vehicle door 2, wherein the window frame can, for example, comprise the beltline 11. In particular, the window frame is part of the base body 4, for example. In the closed position, the side window 12 is arranged at least partially in the window region 15, in particular such that the window opening is at least partially, in particular at least predominantly and thus at least more than half or completely, closed by the side window 12. In particular, it is intended that in the closed position (window closed position) of the side window 12, the beltline 11 in the installed position of the vehicle door 2 adjoins the side window 12 at the bottom in the vertical direction of the vehicle, in particular in relation to the closed position of the vehicle door 2.

It can be seen from FIG. 2 that the vehicle door 2 has a shaft 16, also known as a pane shaft or window shaft, which, in the installed position of the vehicle door 2 and in the closed position of the vehicle door 2, is formed outwards in the transverse direction of the vehicle and thus towards the surroundings 3, in particular directly, by the body shell 5 and/or the outer paneling element 6. In particular, in the installed position of the vehicle door 2 and in the closed position of the vehicle door 2, the shaft 16 is overlapped outwards in the transverse direction of the vehicle of the motor vehicle 1 and thus towards the surroundings 3 by the outer paneling element 6 and/or the body shell 5. The transverse direction of the vehicle is illustrated in FIG. 2 by a double arrow 17, wherein the closed position and the installed position of the vehicle door 2 are also shown in FIG. 2. In the window open position of the side window 12, a partial region of the side window 12, also referred to as the window partial region, is thus arranged in the shaft 16 and thus in particular outer side the window region 15, in particular such that the window partial region in the open position is arranged below the beltline 11 in the vertical direction of the vehicle 1 and also below the window region 15, in particular in relation to the installed position of the vehicle door 2 and in relation to the closed position of the vehicle door 2. In the closed position (window closed position) of the side window 12, the window partial region is arranged outside the shaft 16 and in the window region 15, in particular such that the window partial region is arranged above the door parapet 11 in the vertical direction of the vehicle, in particular at least in relation to the installed position and to the closed position of the vehicle door 2. In other words, in the window closed position, the door parapet 11 adjoins the window partial region downwards in the vertical direction of the vehicle. For example, in the closed position (window closed position) of the side window 12, the window region 15 or the window opening is at least partially, in particular at least predominantly and thus at least more than half or completely, closed by the window partial region.

The vehicle door 2 also has a handle element 18 which is arranged on the outer side of the door and is also referred to as an outer side handle or outer side door handle. The handle element 18 is arranged above the beltline 11 in the installed position of the vehicle door 2 and in relation to the closed position of the vehicle door 2, in particular at least partially and very preferably at least predominantly or completely, in the vertical direction of the vehicle of the motor vehicle 1. The feature that the handle element 18 is arranged on the outer side of the door or on the exterior, and is therefore an outer-side handle element or handle element which is arranged on the door outer side, is to be understood as meaning that the handle element 18 is arranged on an outer side AS of the vehicle door 2, the outer side AS of which, in the installed position of the vehicle door 2 and at least in the closed position of the vehicle door 2, faces away from the interior and towards the surroundings 3. The person present in the surroundings 3 can, for example, grasp the handle element 18 with their hand and thereby, for example, at least partially grip it and subsequently exert a force, in particular a pulling force, on the handle element 18 in order to thereby, for example, open the initially closed vehicle door 2, and thus move it from the closed position into the open position relative to the body.

The handle element 18 has an outer skin which can be perceived visually and haptically by the person in the vicinity 3 of the vehicle door 2, in particular of the motor vehicle 1 as a whole, also referred to as the handle element outer skin 19, by which, for example, a fourth part of the overall outer skin 8 is formed, and which is therefore in particular a fourth part of the overall outer skin 8.

In order to be able to operate, in particular actuate, the vehicle door 2 particularly easily, in particular ergonomically and comfortably, the handle element 18 has a first partial region TB1, also referred to as the first body region or first body part, with a first direction of extent, which is also referred to as the first direction and is illustrated in FIG. 1 by an arrow 20. The first partial region TB1 extends along the first direction. In the exemplary embodiment shown in FIG. 1, it is intended that the first partial region TB1 protrudes in the first direction (arrow 20) from the base body 4, in particular from the cladding element 7. In particular, the first direction extends in the installed position of the vehicle door 2 and in relation to the closed position of the vehicle door 2 in the transverse direction of the vehicle, in particular outwards. The handle element 18 also has a second partial region TB2, which is also referred to as the second body region or second body part. The second partial region TB2 protrudes from the first partial region TB1 in a second direction of extent illustrated in FIG. 1 by an arrow 21, which is also referred to as the second direction. The second partial region TB2 extends along the second direction of extent. It can be seen from the arrows 20 and 21 that the first direction and the second direction run perpendicularly or at an angle to each other, wherein the second direction in the present case points upwards in the vertical direction of the vehicle, in particular in the installed position of the vehicle door 2 and in relation to the closed position of the vehicle door 2. In particular, the second partial region TB2 adjoins an end of the partial region TB1 that faces away from the base body 4, in particular along the first direction, so that or as a result of which, in the first embodiment, the handle element 18 is L-shaped, in particular when viewed as a whole, and thus has an L-shape, in particular when viewed as a whole. The L-shape is formed by the partial regions TB1 and TB2. Thus, the handle element 18 is L-shaped in the first embodiment. The partial regions TB1 and TB2 are respective legs of the L-shape, wherein the handle element 18 is connected to the base body 4, in particular to the body shell 5, via the partial region TB1. The partial region TB2 adjoins the partial region TB1, in particular in the present case in such a way that the partial region TB2 adjoins an end of the first partial region TB1 that faces away from the base body 4, in particular along the first direction.

In order to be able to realize a particularly advantageous operation, an operating element 22, which is shown particularly schematically in FIG. 2, is integrated into the handle element 18, in particular in the second partial region TB2, which is arranged in particular on an inner side S1 of the handle element 18, in particular of the second partial region TB2, facing the base body 4, in particular the cladding element 7. It can be seen particularly clearly from FIG. 2 that the partial regions TB1 and TB2 are arranged above the beltline 11 in the installed position of the vehicle door 2 and, in relation to the closed position of the vehicle door 2, in the vehicle vertical direction of the motor vehicle 1. The operating element 22 is arranged above the door parapet 11 in the installed position of the vehicle door 2 and above the door parapet 11 in relation to the closed position of the vehicle door 2 in the vertical direction of the vehicle 1. By way of the operating element 22, a lock designed in the present case as a door lock can be electrically unlocked by operating, in particular actuating, the operating element 22. The lock is, for example, a component of the vehicle door 2 and can therefore be moved, in particular pivoted, with the vehicle door 2 relative to the body of the motor vehicle 1 between the open position and the closed position of the vehicle door 2. By way of the lock, the vehicle door 2 can be held in the closed position relative to the body and thus secured in the closed position, so that the vehicle door 2 can be secured by way of the lock against a movement relative to the body from the closed position into the open position. For this purpose, the lock is or is locked in the closed position of the vehicle door 2, i.e., the lock is moved into a locked state. By operating the control element 22, the lock can be electrically unlocked, i.e., electrically moved, i.e., transferred, from the locked state to an unlocked state of the lock. By moving the lock from the locked state to the unlocked state of the lock, the lock releases the vehicle door 2, which is initially in the closed position, for a movement from the closed position to the open position relative to the body of the motor vehicle 1.

In order to be able to realize a particularly advantageous, in particular a particularly safe, operation of the vehicle door 2, it is also provided that the handle element 18 is held on the base body 4, in particular on the body shell 5, so as to be movable relative to the base body 4 and thus relative to the body shell 5, relative to the outer paneling element 6, relative to the cladding element 7 and also relative to the side window 12 from a rest position shown in FIGS. 1, 2 and 3 into an actuating position B shown in FIG. 4, in particular between the rest position R and the actuating position B. By moving the handle element 18 from the rest position R into the actuating position B, the lock can be unlocked, in particular purely mechanically, and thus transferred, in particular purely mechanically, from the locked state to the unlocked state.

In the first embodiment shown in FIGS. 1 to 4, the handle element 18 is pivotable relative to the base body 4 about a pivot axis SA between the rest position R and the actuating position B. In the first embodiment, the pivot axis SA extends in the closed position of the vehicle door 2 and, in relation to the installed position of the vehicle door 2, at least substantially in the vertical direction of the vehicle, which is illustrated, for example, in FIG. 4 by a double arrow 23 and extends perpendicular to the image plane of FIG. 4. In the first embodiment, the handle element 18 can be pivoted forwards from the rest position R into the actuating position B in relation to the closed position and in relation to the installed position of the vehicle door 2 in the longitudinal direction of the vehicle, which is illustrated in FIGS. 2 and 4 by a respective arrow 24. In the first embodiment, the lock is unlocked, in particular purely mechanically, for example in the following way: A pulling element 25, also known as a cable element, is provided, which is designed, for example, as a wire or a wire cable. In particular, the pulling element 25 is designed as a Bowden cable, for example. The pulling element 25 is coupled on the one hand, in particular at one end, to the handle element 18, in particular mechanically. On the other hand, in particular at the other end, the pulling element 25 is coupled, for example, to the lock, in particular mechanically. If, for example, the handle element 18 is moved manually from the rest position R to the actuating position B relative to the base body 4 by the person in the vicinity 3, a force in the form of a tensile force acts on the pulling element 25, in particular from the handle element 18, which is transmitted to the lock via the pulling element 25 and subsequently unlocks the lock, i.e., transfers it from the locked state to the unlocked state. As a result, the vehicle door 2 can be opened, i.e., moved from the closed position to the open position relative to the body. In simple terms, moving the handle element 18 from the rest position R to the actuating position B pulls on the pulling element 25, whereby the lock is unlocked mechanically, in particular purely mechanically, i.e., without using any electrical or other energy.

FIG. 2 shows, for example, that a holder 26, also known as a retaining element, is provided. The holder 26 is formed separately from the body shell 5, for example, and is fastened to the body shell 5, in particular by at least one or more screws. In other words, for example, the holder 26 is screwed to the body shell 5. The handle element 18 is held movably relative to the body shell 5 on the body shell 5 and thus on the base body 4 between the rest position R and the actuating position B by way of the holder 26, in particular in such a way that the handle element 18 is held movably relative to the holder 26 on the holder 26 between the rest position R and the actuating position B.

The vehicle door 2 is designed such that when the operating element 22 is operated and the lock is electrically unlocked as a result, the handle element 18 does not move from the rest position R to the actuating position B, i.e., the handle element 18 remains in its rest position R, in particular such that relative movements between the handle element 18 and the base body 4 do not occur. A retaining device 27 is provided for this purpose, which is also referred to as a force coupling or can be designed as a force coupling. The retaining device 27 secures the handle element 18 relative to the base body 4 in the rest position R up to a limit force and permits, in particular purely passively, the movement of the handle element 18 relative to the base body 4 from the rest position R into the actuating position B, in particular when and in particular only when an actuating force acting on the handle element 18 and intended for moving the handle element 18 from the rest position R into the actuating position B exceeds the limit force. Preferably, the limit force is greater than 90 newtons. For this purpose, for example, the retaining device 27 comprises at least one spring element 28, which is designed as a torsion spring, for example, and which is a mechanical spring in the present case. Via the spring element 28, for example, the handle element 18 can be supported or braced at least indirectly on the base body 4, in particular on the body shell 5, in particular in such a way that the spring element 28 is supported or braced at least indirectly, in particular directly, on the handle element 18 on the one hand and at least indirectly, in particular directly, on the base body 4, in particular on the body shell 5, on the other hand. The spring element 28 provides a spring force which secures the handle element 18 in the rest position R and, in particular purely, passively permits the movement of the handle element 18 relative to the base body 4 from the rest position R into the actuating position B, if and preferably only if an actuation force acting on the handle element 18 exceeds the limit force. In other words, the handle element 18 can only be moved against the spring force from the rest position R into the actuating position B and, in particular, only from the rest position R into the actuating position B relative to the base body 4 if the actuating force exceeds the limit force.

Preferably, the rest position R is a stable position in which there is no relative movement between the handle element 18 and the base body 4. In particular, for example, the handle element 18 is held in the rest position R relative to the base body 4 by way of the retaining device 27, in particular in such a way that relative movements between the handle element 18 and the base body 4 are avoided. Quite preferably, the actuating position B is a particularly further stable position of the handle element 18, wherein the handle element 18 is preferably movable into the actuating position B and can be locked relative to the base body 4 in the actuating position B, in particular in such a way that relative movements between the handle element 18 and the base body 4 do not occur in the actuating position B. For this purpose, for example, a locking device is provided by way of which the handle element 18, after it has been moved from the rest position R into the actuating position B, can be held or is held in the actuating position B relative to the base body 4.

It can be seen that the limit force is a force threshold which must be overcome in order to be able to move the handle element 18 relative to the base body 4, in particular into the actuating position B or in the direction of the actuating position B. Alternatively or additionally, the retaining device 27 can for example have two retaining elements, for example in the form of disks, namely a first retaining element, for example at least indirectly, in particular directly, attached to the body shell 5, and a second retaining element, for example at least indirectly provided on the handle element 18 and movable with the handle element 18. One of the retaining elements has, for example, at least one or more projections, in particular knobs. The other retaining element has, for example, at least one or more indentations corresponding to the projections, wherein, for example, the respective projection engages in the respective corresponding indentation in the rest position R. In order to be able to move the handle element 18 relative to the base body 4, in particular to be able to move it from the rest position R into the actuating position B, the respective projection must be moved out of the respective corresponding indentation, in particular pivoted out of it. To do this, the limit force (force threshold) must be overcome. Alternatively or additionally, it is conceivable that the handle element 18 is form-fittingly held in the rest position R, in particular latched in the rest position R, by way of the retaining device 27. In order to be able to move the handle element 18 relative to the base body 4, in particular from the rest position R to the actuating position B, the form fit must be released, i.e., the handle element 18 must be unlocked. Only then can the handle element 18 be moved from the rest position R to the actuating position B. This ensures advantageous and unambiguous operation or actuation of the vehicle door 2. In particular, for example, the person in the vicinity 3 can exert an operating force on the operating element 22 in order to cause the lock to unlock electrically. For this purpose, for example, the operating force of the person acts on the operating element 22 in one operating direction. If the operating force is less than the limit force or if the operating force corresponds to the limit force, the handle element 18 remains in the rest position R. However, if the operating force exceeds the limit force, the handle element 18 is moved from the rest position R into the actuating position B relative to the base body 4. Thus, the lock can be mechanically unlocked, so to speak, in continuation of the operation of the operating element 22 via the handle element 18, since the person can exert the operating force in the same direction on the operating element 22 and via this on the handle element 18 in order to effect the electrical unlocking and the mechanical unlocking of the lock. To mechanically unlock the lock, however, the operating force must exceed the limit force.

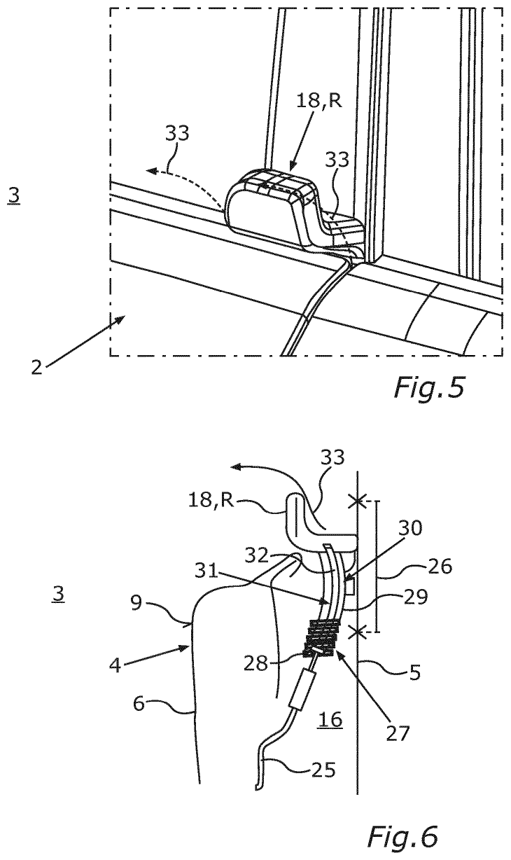

FIGS. 5 and 6 show a second embodiment of the vehicle door 2. In FIGS. 5 and 6, the movement or movability of the handle element 18 from the rest position R to the actuating position B is illustrated by arrows 33. In the second embodiment, the vehicle door 2 has a first guide device 29 provided on the base body 4, in particular the body shell 5. The first guide device 29 is, for example, at least indirectly, in particular directly, fixed to the body shell 5 and is thus, for example, immovable relative to the body shell 5. The first guide device 29 has a guide link 30. A second guide device 31 is provided on the handle element 18, which can be moved with the handle element 18 relative to the base body 4 from the rest position R into the actuating position B, in particular between the rest position R and the actuating position B. The second guide device 31 comprises at least one guide element 32, which engages in the guide link 30. As a result, the guide devices 29 and 31 interact form-fittingly. As a result, the guide devices 29 and 31 define or form a path of movement, illustrated in particular by the arrow 33 shown in FIG. 6, along which the handle element 18 can be moved in a guided manner relative to the base body 4 from the rest position R into the actuating position B, in particular between the rest position R and the actuating position B.

For example, the guide device 29 is held at least indirectly on the body shell 5, for example via the holder 26. It is also conceivable that the guide device 29 is held directly on the body shell 5. It is also conceivable that the guide device 29 is attached, in particular fixed, directly to the holder 26 and to the body shell 5 via the holder 26. FIG. 6 shows particularly clearly that in the second embodiment, the path of movement is arcuate, in this case in such a way that in the installed position of the vehicle door 2 and in relation to the closed position of the vehicle door 2, the arcuate path of movement is curved towards the interior of the motor vehicle 1 and thus curved away from the surroundings 3. Thus, on its path from the rest position R to the actuating position B, the handle element 18 moves upwards in the vehicle vertical direction and outwards in the vehicle transverse direction, and thus away from the interior, in particular with respect to the installed position of the vehicle door 2 and with respect to the closed position of the vehicle door 2. Expressed again in other words, the handle element 18 in the actuating position B is thus arranged further upwards in the vertical direction of the vehicle and further outwards in the transverse direction of the vehicle, and thus further away from the interior, in particular with respect to the closed position and the installed position of the vehicle door 2, compared to the inoperative position R. This is realized in the present case in such a way that the guide link 30 is curved towards the interior in the installed position and in the closed position of the vehicle door 2.

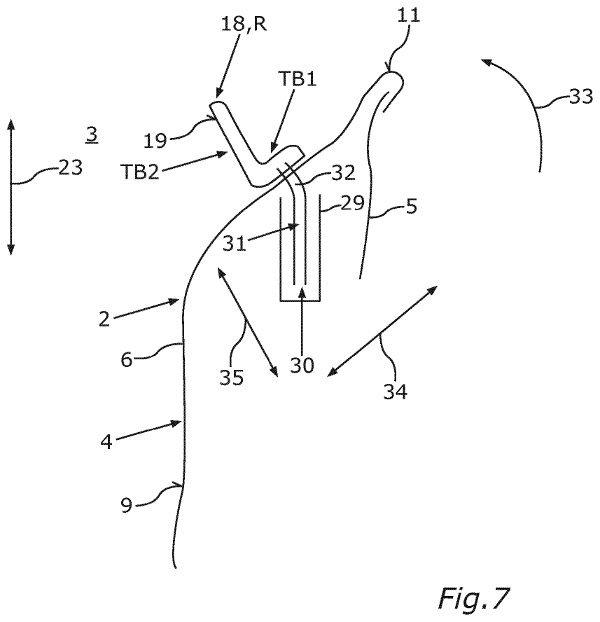

FIG. 7 shows a schematic sectional view of a detail of a third embodiment of the vehicle door 2. The third embodiment differs in particular from the second embodiment in that, in the third embodiment, the handle element 18, and thus the partial regions TB1 and TB2, are arranged completely below the beltline 11 in the installed position of the vehicle door 2 and in the closed position of the vehicle door 2 in the vehicle vertical direction (double arrow 23).

In the third embodiment, the handle element 18 also comprises the handle element outer skin 19, wherein the partial region TB1 forms or comprises a first part and the partial region TB2 forms or comprises a second part of the handle element outer skin 19. The partial region TB1 has the first direction of extent illustrated in FIG. 7 by a double arrow 34, along which the first partial region TB1 extends. The second partial region TB2 has the second direction of extent illustrated in FIG. 7 by a double arrow 35, along which the second partial region TB2 extends. It can be seen that the directions of extent run diagonally or, in the present case, perpendicular to each other. In the third embodiment, the partial regions TB1 and TB2 also form an L-shape of the handle element 18, which is therefore also L-shaped overall in the third embodiment. In this case, the partial regions TB1 and TB2 are legs of the L-shape. In the rest position R shown in FIG. 7, the first direction of extent runs parallel to a plane in which an outer skin part of the paneling outer skin 9 of the outer paneling element 6 extends. It is conceivable that, in the rest position R, the partial region TB1 is in contact, in particular directly, with the outer skin part of the paneling outer skin 9. Thus, for example, in the third embodiment, the partial region TB2 protrudes along or in the second direction of extent from the partial region TB1 and from the outer skin of the paneling 9. The previous and following explanations relating to the first embodiment and to the second embodiment can also be readily transferred to the third embodiment and vice versa. Since the handle element 18 is also at least substantially L-shaped in the third embodiment, an ergonomic and convenient operation, in particular actuation, of the handle element 18 and thus of the vehicle door 2 as a whole can also be shown in the third embodiment. In particular, it can be seen from FIG. 7 that the second partial region TB2 projects along or in the second direction of extent from the partial region TB1, in particular from its end, to which the partial region TB2 is connected, in particular only in the second direction of extent. In particular, it is intended that the handle element 18 as a whole, i.e., viewed overall, has an L-shape, i.e., is L-shaped.

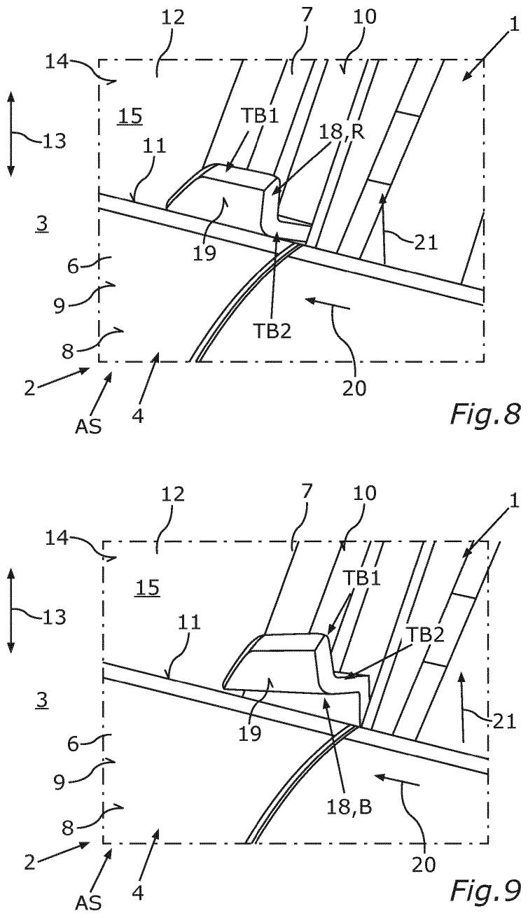

Lastly, FIGS. 8 to 11 show a fourth embodiment of the vehicle door 2. Also in the fourth embodiment, the handle element 18 is pivotable, in particular rotatable, about the pivot axis SA relative to the base body 4 from the rest position R into the actuating position B in order thereby to mechanically unlock, in particular to emergency unlock, the lock, which is illustrated schematically in FIG. 11 and is denoted by 36. In particular, the handle element 18 is pivotable about the pivot axis SA relative to the base body 4 between the rest position R and the actuating position B. In the fourth embodiment, in the installed position of the vehicle door 2 and in the closed position of the vehicle door 2, the pivot axis SA runs in the transverse direction of the vehicle (double arrow 17), which is also referred to as y or the y direction. Therefore, the handle element 18, that is at least a partial region of the handle element 18, can be pivoted about the pivot axis SA relative to the base body 4 and upward in the vertical direction of the vehicle (double arrow 13) from the rest position R into the actuating position B in order to be able to realize a particularly advantageous operation. In particular, it is conceivable that the handle element 18 is movable, in particular pivotable, in particular only by overcoming the above-mentioned limit force or limit force from the rest position R into the actuating position B. Therefore, the person when wishing to move the handle element 18 from the rest position R into the actuating position B has to overcome the limit force which opposes or is opposed to the movement of the handle element 18 from the rest position R into the actuating position B and/or holds the handle element 18 in the rest position R and, for example, secures it against a movement from the rest position R into the actuating position B, in particular for as long and only as long as an external force acting on the handle element 18 and provided for moving the handle element 18 from the rest position R into the actuating position B, for example the above-mentioned actuating force, exceeds the limit force. For example, the handle element 18 is secured or held in the rest position R by way of the retaining device 27, in particular by way of the above-mentioned spring force, wherein the retaining device 27, in particular the spring force, is or defines or provides the limit force.

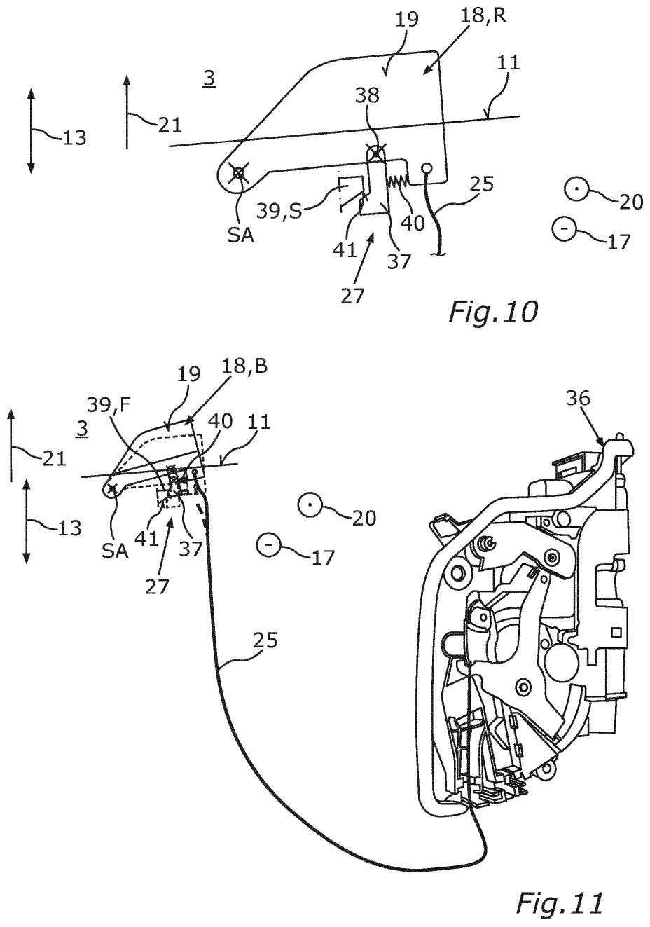

As can be seen from FIGS. 10 and 11, in the fourth embodiment, the retaining device 27 is designed, for example, as a pawl mechanism, or, in the fourth embodiment, the retaining device 27 comprises, for example, a pawl mechanism. The pawl mechanism comprises a pawl 37 which, for example, is held on the handle element 18 so as to be pivotable about a further pivot axis 38 relative to the handle element 18. Therefore, the pawl 37 is movable, in particular pivotable, at the same time here as the handle element 18 from the rest position R into the actuating position B, in particular between the rest position R and the actuating position B. In the fourth embodiment, for example, the pivot axis 38 runs parallel to the pivot axis SA. The pawl mechanism also comprises a securing element 39 which is provided on the base body 4 and is fastened, for example at least indirectly, in particular directly, to the body shell 5. It can be seen from FIGS. 10 and 11 that the pawl 38, which is also referred to as the securing pawl, is held on the handle element 18 so as to be pivotable about the pivot axis 38 relative to the handle element 18 between at least one securing position S, which can be seen in FIG. 10, and at least one release position F, which can be seen in FIG. 11.

In the rest position R of the handle element 18 and in the securing position S of the pawl 37, the pawl 37 engages behind the securing element 39, in particular behind a side of the securing element 39 which faces away from at least a partial region of the handle element 18 and in the present case, in the installed position of the vehicle door 2 and in the closed position of the vehicle door 2, faces downward in the vertical direction of the vehicle, as a result of which the pawl 36 and the securing element 39 secure the handle element 18 against a movement taking place here in the vertical direction of the vehicle and relative to the base body 4, in particular pivoting movement, from the rest position R into the actuating position B.

The pawl mechanism also comprises a spring element 40 which on one side, in particular at one end, is at least indirectly, in particular directly, coupled to the pawl 37 and on the other side, in particular at the other end, to the handle element 18. The securing element, in particular on its above-mentioned side which, in the installed position of the vehicle door 2 and in the closed position of the vehicle door 2, faces downward in the vertical direction of the vehicle, has a bevel 41 which is also referred to as a slide-off bevel or is designed as a slide-off bevel. In the installed position of the vehicle door 2 and in the closed position of the vehicle door 2, the bevel 41 runs obliquely to the vertical direction of the vehicle, and also the bevel 41 here runs parallel to the pivot axis 38. By pivoting of the pawl 37 about the pivot axis 38 and relative to the handle element from the securing position S into or in the direction of the release position F, the spring element 40 is or will be tensioned, as a result of which the spring element 40 provides a spring force which counteracts or opposes the movement of the pawl 37 from the securing position S into the release position F. For example, in the securing position S of the pawl 37, the spring element 40 is tensioned, and therefore the spring element 40 provides its spring force, for example, even in the securing position S. By this, the pawl 37 is held in the securing position S. For example, the spring force which is provided or can be provided by the spring element 40 is or defines or brings about the limit force, i.e. the force threshold, which is to be overcome or has to be overcome in order to move the handle element 18 from the rest position R into the actuating position B and, in consequence, to mechanically unlock the lock 36. In other words, the limit force depends on the spring force of the spring element 40.

If, for example, the person in the surroundings 3 exerts a force provided for moving the handle element from the rest position R into the actuating position B and exceeding the limit force, in particular the actuating force, on the handle element 18, in particular by the person pulling on the handle element 18, in particular upward in the vertical direction of the vehicle, the pawl 37 then slides on the bevel 41, as a result of which the pawl 37 is pivoted counter to the spring force of the spring element 40 from the securing position S into the release position F, and the handle element 18 is moved from the rest position R into the actuating position B.

The pawl mechanism and/or the retaining device 27 can be designed or can act in the manner of a push-push mechanism. This means that, for example, the person in the surroundings 3 exerts a force, in particular a compressive force, on the handle element 18, which is initially in the rest position R, in order thereby to move the handle element 18 firstly for a distance away from the actuating position B and, in the process, for example, into a release position. For example, the release position is an end position, and therefore the handle element 18 can be moved into the release position but not beyond the release position. In the fourth embodiment, in the installed position of the vehicle door 2 and in the closed position of the vehicle door 2, force exerted on the handle element 18 acts downward in the vertical direction of the vehicle, and the handle element 18 is thereby moved, in particular pivoted, downward in the vertical direction of the vehicle relative to the base body 4 and thus for a distance away from the actuating position B, in particular into the release position. The person can then let go of the handle element 18. In other words, the exertion of the force on the handle element 18 ends, whereupon the handle element 18 moves by way of the push-push mechanism, in particular by way of at least one spring of the push-push mechanism, and therefore, for example, without action of a person, for example, from the release position into the actuating position B, as a result of which the lock 36 is mechanically unlocked, or else the handle element 18, after it has moved into the release position and after the exerting of the force on the handle element 18 has ended, is moved, for example without action of a person, by way of the push-push mechanism from the release position into an intermediate position which lies, for example, between the rest position R and the actuating position B, which can be, for example, an in particular further end position of the handle element 18. For example, the person can then move the handle element 18 manually from the intermediate position into the actuating position B, as a result of which the lock 36 is mechanically unlocked.

In the fourth embodiment, it is provided in particular that the entire handle element 18 pivots by pivoting or rotation of the handle element 18 about the pivot axis SA, which is also referred to as the axis of rotation. If, in the process, the handle element 18 is pivoted into the actuating position B, the lock 36 is mechanically unlocked, in particular emergency unlocked. One advantage of the fourth embodiment is in particular that loose parts can be avoided, and therefore a very simple operation can be realized so that the handle element 18 can be intuitively actuated in an emergency and moved into the actuating position B, as a result of which the lock 36 can be intuitively unlocked.

List of reference signs

| | |
|---|---|
| 1 | motor vehicle |
| 2 | vehicle door |
| 3 | surroundings |
| 4 | base body |
| 5 | body shell |
| 6 | outer paneling element |
| 7 | cladding element |
| 8 | overall outer skin |
| 9 | paneling outer skin |
| 10 | cladding element outer skin |
| 11 | beltline |
| 12 | side window |
| 13 | double arrow |
| 14 | window outer skin |
| 15 | window region |
| 16 | shaft |
| 17 | double arrow |
| 18 | handle element |
| 19 | handle element outer skin |
| 20 | arrow |
| 21 | arrow |
| 22 | control element |
| 23 | double arrow |
| 24 | arrow |
| 25 | pulling element |
| 26 | holder |
| 27 | retaining device |
| 28 | spring element |
| 29 | first guide device |
| 30 | guide link |
| 31 | second guide device |
| 32 | guide element |
| 33 | arrow |
| 34 | double arrow |
| 35 | double arrow |
| 36 | lock |
| 37 | pawl |
| 38 | pivot axis |
| 39 | securing element |
| 40 | spring element |
| 41 | bevel |
| AS | outer side |
| B | actuating position |
| F | release position |
| R | rest position |
| S | securing position |
| S1 | inner side |
| SA | pivot axis |
| TB1 | partial region |
| TB2 | partial region |

1.-12. (canceled)

13. A vehicle door for a motor vehicle, having a handle element which is arranged on the outer side of the door, arranged above a beltline of the vehicle door, wherein:
an operating element is integrated into the handle element, by way of which operating element a lock, by way of which the vehicle door, which can be arranged on a body of the motor vehicle so as to be movable between a closed position and at least one open position, can be secured in the closed position, can be electrically unlocked; and
the handle element is held on the base body so as to be movable relative to the base body of the vehicle door from a rest position (R) into at least one actuating position (B), wherein the lock is able to be mechanically unlocked by moving the handle element from the rest position (R) into the actuating position (B).

14. The vehicle door according to claim 13, wherein the handle element has:
an outer skin that can be perceived visually and haptically by a person standing in the surroundings of the vehicle door;
a first partial region (TB1) forming a first part of the outer skin of the handle element and having a first direction of extent; and
a second partial region (TB2) forming a second part of the outer skin of the handle element and adjoining the first partial region (TB1), which second partial region projects from the first partial region (TB1) in at least one second direction of extent extending obliquely or perpendicularly to the first direction of extent.

15. The vehicle door according to claim 14, wherein:
as a result of the second partial region (TB2) projecting from the first partial region (TB1) in the second direction of extent the handle element is L-shaped or V-shaped.

16. A vehicle door for a motor vehicle, having a handle element which is arranged on the outer side of the door, below a beltline of the vehicle door, wherein:
an operating element is integrated into the handle element, by way of which a lock, by way of which the vehicle door, which can be arranged on a body of the motor vehicle so as to be movable between a closed position and at least one open position, can be secured in the closed position, can be electrically unlocked;
the handle element is held on the base body so as to be movable relative to a base body of the vehicle door from a rest position (R) into at least one actuating position (B), wherein the lock is mechanically unlockable by moving the handle element from the rest position (R) into the actuating position (B); and
the handle element has:
an outer skin that can be perceived visually and haptically by a person standing in the surroundings of the vehicle door;
a first partial region (TB1) forming a first part of the outer skin of the handle element and having a first direction of extent; and
a second partial region (TB2) forming a second part of the outer skin of the handle element and adjoining the first partial region (TB1), which second partial region projects from the first partial region (TB1) in at least one second direction of extent extending obliquely or perpendicularly to the first direction of extent, whereby the handle element is L-shaped or V-shaped.

17. The vehicle door according to claim 16, wherein:
a first guide device is provided on the base body;
a second guide device is provided on the handle element, which interacts with the first guide device, whereby the handle element can be moved in a guided manner relative to the base body along a path of movement predetermined by the interacting guide devices between the rest position (R) and the actuating position (B).

18. The vehicle door according to claim 17, wherein the path of movement is arcuate.

19. The vehicle door according to claim 18, wherein in the installed position of the vehicle door and in the closed position of the vehicle door, the arcuate path of movement is curved towards the interior of the motor vehicle.

20. The vehicle door according to claim 16, wherein:
a retaining device secures the handle element relative to the base body in the rest position (R) up to a limit force and passively permits the movement of the handle element relative to the base body from the rest position (R) into the actuating position (B) when an actuating force acting on the handle element exceeds the limit force.

21. The vehicle door according to claim 20, wherein the limit force is greater than 50 Newtons.

22. The vehicle door according to claim 16, wherein the handle element can be pivoted about a pivot axis (SA) relative to the base body between the rest position (R) and the actuating position (B).

23. The vehicle door according to claim 22, wherein the pivot axis (SA) runs in the vertical direction of the vehicle or in the longitudinal direction of the vehicle when the vehicle door is in the installed position.

24. A motor vehicle, comprising at least one vehicle door according to claim 16.
